(19) United States
(12) Patent Application Publication
(10) Pub. No.: US 2005/0064817 A1
(43) Pub. Date: Mar. 24, 2005

(54) Device, system and method for adaptation of collision avoidance mechanism for wireless network

(76) Inventor: Boris Ginzburg, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/668,173

(22) Filed: Sep. 24, 2003

(51) Int. Cl. H04B 5/00

(52) U.S. Cl. 455/41.2

(57) ABSTRACT

A device, system and method for adaptation of a collision avoidance mechanism or parameters of such mechanisms for a wireless network. For example, parameters of a contention window mechanism, a request-to-send mechanism, or other delay or collision avoidance mechanisms, may adaptively or dynamically be set or modified. For example, a size of a contention window of a collision avoidance mechanism may be adapted, set or modified, for example, based on an estimated number of active stations of a communication network. A network device may, for example, adaptively or dynamically modify a property or a parameter used for calculation of the size of a contention window. Such modification may be performed, for example, in relation to a parameter or a property of a wireless communication network, such as a probability of collisions or an estimated number of active wireless communication devices.

### BACKGROUND OF THE INVENTION

In the field of wireless communication, a Wireless Local Area Network (WLAN) may include one or more wireless stations communicating with one or more wireless terminals such as Access Points (APs). Wireless communication may be performed in accordance with suitable standards, for example, Institute of Electrical and Electronics Engineers (IEEE) 802.11 standard, IEEE 802.11a standard, IEEE 802.11b standard, or IEEE 802.11g standard. Sharing of a wireless communication channel may be performed in accordance with suitable mechanisms, for example, a Distributed Coordination Function (DCF) based on Carrier Sense Multiple Access with Collision Avoidance (CSMA/CA). In accordance with existing standards and protocols, sharing of a wireless communication channel may be problematic and non-optimal, and may decrease throughput. For example, there is a need to determine the operational result when multiple wireless stations compete for transmission time in a wireless communication network. When a wireless channel becomes idle, a wireless station may detect that the wireless channel is idle, and may then wait a random “backoff time”, which may be termed a Contention Window (CW), before transmitting a packet or other set of information. According to some standards and protocols, a wireless station may wait a fixed period of time, which may be termed a Distributed Inter-Frame Space (DIFS), and then may wait a pseudo-random period of time equal to R number of time-slots, wherein R may be a uniformly distributed pseudo-random number which satisfies, for example, the following condition: 0<=R<=Contention Window Size (CWS). CWS may be, for example, a maximum size for a CW, wherein a CW may have a variable size.

In one system, CWS is initially set equal to a pre-defined minimum value, CWₘᵢₙ. At the end of the waiting period, the wireless station may transmit a packet or other set of information if the wireless channel is still idle, or may further wait if the wireless channel is not idle. The value of CWS increases (e.g., doubles) with consecutive waiting sessions, until the value of CWS reaches a pre-defined maximum value, CWₘₐₓ. The values of CWₘᵢₙ and CWₘₐₓ are pre-defined by the wireless communication standard being used. For example, in accordance with 802.11a standard, CWₘᵢₙ equals 15 and CWₘₐₓ equals 1,023; and in accordance with 802.11b standard, CWₘᵢₙ equals 31 and CWₘₐₓ equals 1,023.

Such a mechanism of random waiting periods by multiple wireless stations allows a partial mitigation of transmission collisions. In addition to or instead of a CW mechanism, other mechanisms may be used for transmission collision avoidance, for example, sending and/or receiving Request-to-Send (RTS) control frames and/or Clear-to-Send (CTS) control frames. However, current use of these mechanisms may result in non-optimal waiting periods by one or more wireless stations, non-optimal mitigation of collisions, and/or decrease in throughput and wireless network efficiency.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic illustration of a wireless communication station in accordance with an embodiment of the invention;

FIG. 2 is a schematic illustration of a network in accordance with an embodiment of the invention;

FIG. 3 is a flow chart diagram of a method of adaptation of parameters used for calculation of the size of a CW in accordance with an embodiment of the invention; and

FIG. 4 is a schematic illustration of a possible time/transmission graph resulting from the operation of a method according to one embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

Embodiments of the invention may be used in a variety of applications. Although the invention is not limited in this respect, embodiments of the invention may be used in, for example, a personal computer, a workstation, a desktop computer, a mobile computer, a laptop computer, a notebook computer, a Personal Digital Assistant (PDA) device, a tablet computer, a server computer, a network, a Local Area Network (LAN), a Wireless LAN (WLAN), a modem, a wireless modem, a wireless communication device, a Wireless Metropolitan Area Network (WMAN), a Broadband Wireless Access (BWA) device and/or network, devices and/or networks operating in accordance with, for example, the IEEE 802.11, 802.11a, 802.11b, 802.1 g, 802.11n, 802.16, 802,16a, and/or 802.16e standards, a Personal Area Network (PAN), Wireless PAN (WPAN), units and/or devices which are part of WLAN and/or WMAN and/or PAN and/or WPAN networks, one way and/or two-way radio communication systems, and the like.

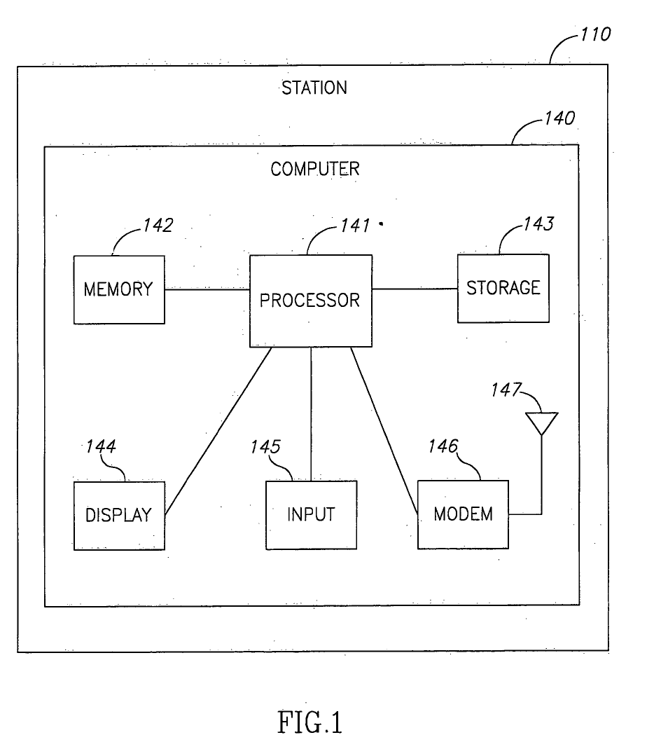

FIG. 1 schematically illustrates a wireless communication station 110 in accordance with some embodiments of the invention. Station 110 may operate using adaptation of parameters or properties used for calculation of the size of a CW or other delay or collision avoidance time period in accordance with embodiments of the invention as described below. Station 110 may be a device operating on a network and communicating wirelessly with other elements of the network. For example, station 110 may include a personal computer, a workstation, a desktop computer, a mobile computer, a laptop computer, a notebook computer, a PDA device, a tablet computer, a network device, a network, a wireless communication station, a internal and/or external modem and/or Lax-modem device and/or card, a peripheral device, a WLAN device, or the like.

In the example shown in FIG. 1, station 110 may include a computer 140, which may include, for example, a processor 141, a memory unit 142, a storage unit 143, a display unit 144, an input unit 145, a WLAN modem 146, and an antenna 147. These components may be internal and/or external to station 110 and/or computer 140, or associated with (e.g., connected to, or linked to) station 110 and/or computer 140. Other components or sets of components may be included.

Processor 141 may include, for example, a Central Processing Unit (CPU), a Digital Signal Processor (DSP), or any suitable specific and/or general and/or multi-purpose processor or micro-processor. Memory 142 may include, for example, a Random Access Memory (RAM). Storage unit 143 may include, for example, a hard disk drive, a floppy disk drive, a Compact Disk drive, or a removable or non-removable memory module or storage module. Display unit 144 may include, for example, a monitor. Input unit 145 may include, for example, a keyboard, a mouse, or a touch-pad. It is noted that processor 141, memory 142, storage unit 143, display unit 144 and/or input unit 145 may include other suitable components and/or implementations as is known in the art.

Modem 146 may include, for example, a wireless modem able to operate in accordance with one or more of the 802.11a standard, 802.11b standard, 802.11g standard, 802.1 In standard, 802.16 standard and/or any other suitable standard. Antenna 147 may include an internal and/or external Radio Frequency (RF) antenna, for example, a dipole antenna. Other suitable antennas may be used. It is noted that in some embodiments, modem 146 may include a dedicated unit to perform adaptation of parameters used for calculation of the size of a CW. In accordance with embodiments of the invention, such adaptation may be performed by other suitable components of station 110, for example, processor 141, possibly operating software applications, drivers and/or operating systems associated with station 110 and/or computer 140.

It is noted that station 110 and/or computer 140 may include various other components, and/or may be configured with additional and/or alternative units. Further, station 110 and/or computer 140 may be implemented using any suitable combination of hardware and/or software, and may include any circuit, circuitry, controller, unit or combination of integrated and/or separate units or circuits, as are known in the art, to perform desired functionalities.

It is noted that the terms “circuit” and “circuitry” as used herein, may include any suitable combination of hardware components and/or software components. For example, station 110 may include adaptation circuitry, decision circuitry, analyzing circuitry, processing circuitry, buffers, memories, controllers, gates, and/or various other types of suitable units, components and/or circuitry, which may perform methods and/or operations as described below in accordance with embodiments of the invention, and which may be implemented using any suitable combination of hardware components and/or software components (including, for example, applications, drivers, and/or operating systems) of station 110.

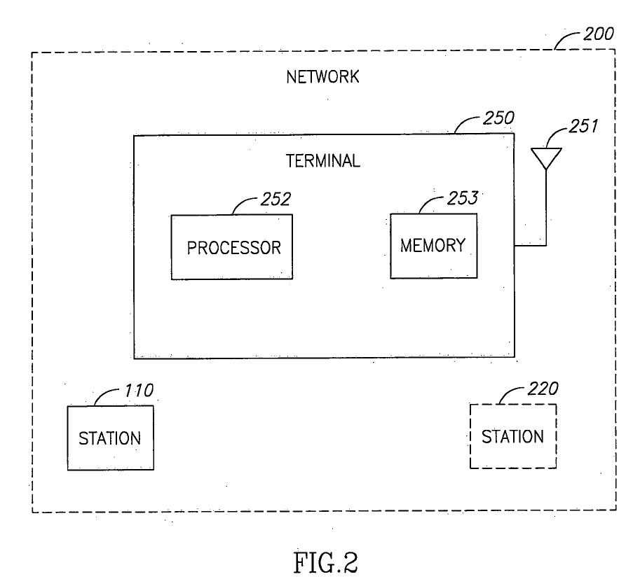

FIG. 2 schematically illustrates a network 200 in accordance with an embodiment of the invention. Network 200 may operate using adaptation of parameters used for calculation of the size of a CW in accordance with embodiments of the invention. In some embodiments, network 200 may be implemented, for example, using a WLAN system. In some embodiments, network 200 may include, for example, a station 110 and a station 250. In one embodiment, a plurality of stations 110 may act as devices able and/or wishing to communicate on network 200, and station 250 may act as a network access device such as an AP; however, other network organizations and/or topologies may be possible, and some or all of stations 110 and/or 250 may be peers. Optionally, network 200 may include a plurality of stations which properties, components and/or functionalities may be similar to station 110; for example, network 200 may include a station 220, which properties, components and/or functionalities may be (but need not be) similar to station 110. Optionally, network 200 may include a plurality of terminals which properties, components and/or functionalities may be (but need not be) similar to station 250.

In some embodiments, station 250 may include suitable WLAN AP circuitry, for example, AP circuitry able to operate in accordance with one or more of 802.11a standard, 802.11b standard, 802.11g standard, 802.1 in standard, 802.16 standard and/or other suitable standard. In alternate embodiments, station 250 may include suitable communication station, device, circuitry or functionality, for example, a communication station similar to station 110; such station may include, for example, hardware and/or software components to allow it to operate as an AP, for example, using a “soft-AP” type of software. It is noted that station 250 may optionally include a processor 252, a memory unit 253, and/or other suitable components to achieve various functionalities. Other suitable circuitry and/or communications methods may be used.

Station 250 may include one or more antennas 251. Antenna 251 may include an internal and/or external Radio Frequency (RF) antenna, for example, a dipole antenna. Other types of antennas may be used.

Embodiments of the invention may include devices, systems and methods which may, for example, alter, adapt, set and/or modify one or more properties or parameters of a collision avoidance mechanism. Such modification may be, for example, in relation to a property of a wireless communication network. In some embodiments, a size of a CW of a collision avoidance mechanism may be adapted, set and/or modified, for example, based on an estimated number of active stations of a communication network. For example, a device or method may modify a property or a parameter used in computing a CW, such as, for example, a minimum or maximum size of the CW, an initial minimum size or initial maximum size of the CW, or a non-initial minimum size or a non-initial maximum size of the CW. In some embodiments, a device or method may, for example, adapt, set and/or modify parameters, values and/or properties used for calculating a size of a CW, or other suitable delay or collision avoidance time periods in wireless communication networks. It should be appreciated that for purposes of simplicity, a portion of the discussion is presented in relation to a CW, as well as to parameters and properties used in calculating a size of a CW (such as, for example, CWₘᵢₙ and/or CWₘₐₓ); however, the present invention is not limited in this respect. Embodiments of the present invention may be used, for example, in association with various other suitable delay mechanisms, delay periods, waiting mechanisms, waiting periods, pausing mechanisms, pausing periods, collision avoidance mechanisms, and other suitable mechanisms, as well as with other parameters, functions and/or values used in calculating, measuring, and/or determining properties of such mechanisms. For example, some embodiments of the invention may be used in association with an RTS mechanism and/or a CTS mechanism, as well as with various attributes, parameters and/or threshold values used in such mechanisms.

In a conventional wireless communication network, initially, the value of a maximum current size for a CW, such as CWS, may, for example, be equal to a pre-defined minimum value, such as CWₘᵢₙ, and the value of CWS may increase (e.g., may double) with, for example, consecutive waiting periods, until the value of CWS reaches a pre-defined maximum value, such as CWₘₐₓ. In accordance with embodiments of the invention, properties, parameters and/or values related to the CW and/or the size of the CW, such as the value of CWₘᵢₙ and/or the value of CWₘₐₓ, as well as other suitable parameters, values and/or functions, may be set and/or modified. In some embodiments, such setting and/or modification may be performed dynamically, automatically, repeatedly, continuously, and/or in real time. In some embodiments, such setting and/or modification may be performed in relation to, in response to, or on the basis of, one or more properties of the wireless network. In some embodiments, such setting and/or modification may be performed in relation to, in response to, or on the basis of, an estimated probability of transmission collisions of a wireless network.

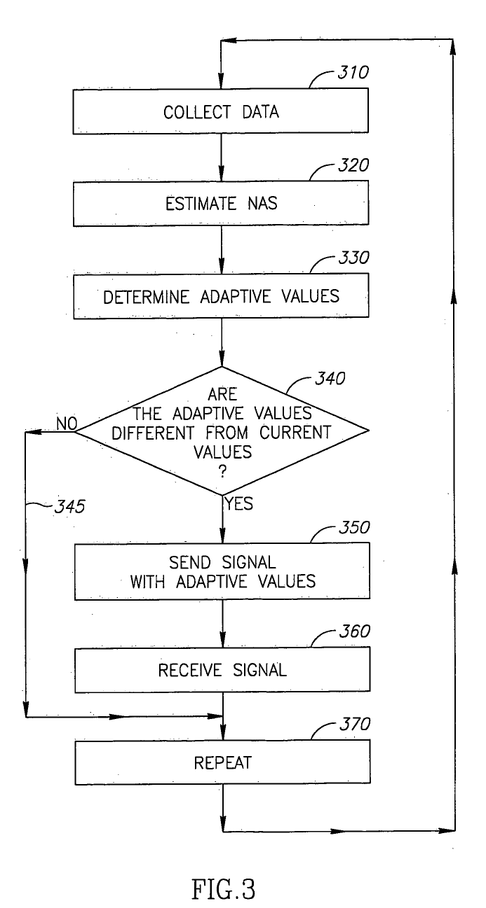

FIG. 3 is a flow chart diagram of a method of adaptation of parameters used for calculation of the size of a CW in accordance with an embodiment of the invention. As indicated at block 310, station 250 may collect and/or receive data, parameters and/or properties about network 200 for a period of time, T1, which may be pre-determined. In some embodiments, T1 may be equal to, for example, five seconds; other suitable periods of time may be used. The data collected by station 250 may include, for example, transmission packets, transmission frames and/or transmission data received by station 250; other suitable data may be collected. The data collected by station 250 may include information on wireless stations in network 200 from which station 250 received, or recently received, a transmission. It is noted that the data collection may be performed using suitable hardware components and/or software components of station 250, for example, using processor 252 and/or memory 253. Other suitable units, controllers and/or components may be used.

As indicated at block 320, a Number of Active Stations (NAS) in network 200 may be estimated. In accordance with some embodiments of the invention, an active station may include any wireless station from which station 250 received a unicast transmission (e.g., a transmission from a wireless station to station 250); other criteria may be used to identify or define an active station. In some embodiments, the NAS estimation may be performed by station 250, for example, by analyzing transmissions received by station 250 and/or by analyzing data collected by station 250. In other embodiments, where other parameters are used to determine values or other collision avoidance parameters, a NAS need not be estimated or determined.

As indicated at block 330, one or more adaptive values may be determined, calculated and/or computed, for example, using station 250. The adaptive values may include, for example, values that may be determined, calculated and/or computed adaptively and/or dynamically to adapt to or to match one or more properties or parameters of a wireless network. In some embodiments, the adaptive values may include values of parameters used in calculation of the size of a CW. In some embodiments, the adaptive values may include, for example, an adaptive value of CWₘᵢₙ and/or an adaptive value of CWₘₐₓ. In some embodiments, the determination of the one or more adaptive values may be performed, for example, in relation to the estimated NAS. In some embodiments, when a relatively small NAS is estimated, relatively small adaptive values may be determined for CWₘᵢₙ and/or CWₘₐₓ. In some embodiments, when a relatively large NAS is estimated, relatively large adaptive values may be determined for CWₘᵢₙ and/or CWₘₐₓ.

In some embodiments, adaptive values for values of parameters used in calculation of the size of a CW, such as CWₘᵢₙ and/or CWₘₐₓ may be determined using, for example, a lookup table. Other suitable methods of determining values may be used. Such lookup table may include, for example, various adaptive values of CWₘᵢₙ and/or CWₘₐₓ, corresponding to various values of estimated NAS and/or to various ranges of values of an estimated NAS. Table 1 includes examples of possible values:

TABLE 1

| Estimated NAS | Adaptive CWₘᵢₙ | Adaptive CWₘₐₓ |
|---|---|---|
| NAS <= 2 | 7 | 31 |
| 2 < NAS <= 4 | 15 | 63 |
| 4 < NAS <= 8 | 31 | 127 |
| 8 < NAS <= 16 | 63 | 255 |
| 16 < NAS | 127 | 1,023 |

It is noted that Table 1 and its values are provided for exemplary purposes only, and that the scope of the invention is not limited in this respect. In accordance with embodiments of the invention, other lookup tables may be used, with similar and/or different values and/or ranges than those of Table 1. Alternatively, embodiments of the invention may operate without using a lookup table, and may use other suitable mechanisms for determining and/or calculating adaptive values, including, for example, adaptive values for CWₘᵢₙ and/or CWₘₐₓ. For example, embodiments of the invention may use mathematical formulae and/or functions to calculate adaptive values of CWₘᵢₙ and/or CWₘₐₓ; such calculation may be performed, for example, in relation to the estimated NAS.

In some embodiments, only an adaptive value for CWₘᵢₙ be determined; in alternate embodiments, only an adaptive value for CWₘₐₓ may be determined; and in other alternate embodiments, adaptive values for CWₘᵢₙ and CWₘₐₓ may be determined. In some embodiments, other adaptive values for other suitable parameters or properties may be determined, for example, parameters or properties that may affect the calculation of a CW, or parameters or properties that may be used in the calculation of a CW.

In some embodiments, one or more adaptive values may be determined, for example, one or more threshold values for sending and/or receiving a control frame. In some embodiments, an adaptive value may be determined for a threshold value, a parameter, a variable, a constant and/or an attribute used in sending and/or receiving an RTS frame and/or a CTS frame, and/or used in association with an RTS/CTS mechanism or other collision avoidance mechanisms. For example, in one embodiment, an adaptive value may be determined for an “RTS_Threshold” attribute, for a “dot11RTSThreshold” attribute, or for other suitable parameters, threshold values and/or attributes. The determinations may be performed, for example, based on or in relation to the estimated NAS, or other suitable parameters. The determinations may be performed, for example, based on one or more lookup tables, formulae, functions and/or suitable calculations. In one embodiment, for example, if the estimated NAS is greater than a pre-defined threshold value, or is smaller than a pre-defined threshold value, then a suitable adaptive value may be determined for one or more threshold values, attributes and/or parameters used in sending and/or receiving a control frame, a control signal, an RTS frame, a CTS frame, or used in other mechanisms of RTS/CTS protection or transmission collision avoidance. It is noted that in some embodiments, adaptive values may be determined for RTS/CTS-related parameters, attributes and/or threshold values; however, the present invention is not limited in this respect, and adaptive values may be determined for various other suitable parameters, attributes and/or threshold values.

In some embodiments, the determinations may be performed one after another, partially in parallel, or substantially in parallel. In some embodiments, a determination of a fsrst adaptive value may be dependent on, or independent from, a determination of a second adaptive value. For example, in some embodiments, the determination of adaptive value for CWₘᵢₙ may be independent of the determination of adaptive value for CWₘₐₓ, or vice versa. In some embodiments, a first lookup table, function and/or formula may be used for the determination of adaptive value for CWₘᵢₙ, and a second lookup table, function and/or formula may be used for the determination of adaptive value for CWₘₐₓ.

The determination of adaptive values for CWₘᵢₙ and/or CWₘₐₓ may be based on, for example, the estimated NAS and/or other suitable criteria or parameters. In some embodiments, the determination may be based on additional and/or alternate data, estimations, criteria, parameters, and/or properties of the wireless network. For example, in some embodiments, the determination of adaptive values for CWₘᵢₙ and/or CWₘₐₓ may be based on the actual number of wireless stations that transmitted data to station 250 within a pre-determined period of time. In alternate embodiments, the determination of adaptive values for CWₘᵢₙ and/or CWₘₐₓ may be based on an estimated probability of transmission collisions; such probability estimation may take into account, for example, an estimated NAS, suitable properties of network 200, suitable properties of station 110, station 220 and/or other stations in network 200, suitable properties of station 250 and/or other terminals or APs in network 200, and/or analysis of transmitted data, parameters, properties, packets and/or frames in network 200.

As indicated at block 340, a check may be performed to determine whether the adaptive values determined are different from current corresponding values. For example, in some embodiments, a check may be performed to determine whether the adaptive values determined for CWₘᵢₙ and/or CWₘₐₓ are different from current corresponding values of CWₘᵢₙ and/or CWₘₐₓ in network 200. This check may be performed, for example, by station 250. In some embodiments, in which adaptive values are determined for RTS/CTS-related threshold values, attributes and/or parameters, the check may include, for example, a determination if the adaptive values are different from current corresponding values.

As indicated by arrow 345, if the check result is negative, then the operations described below in relation to blocks 350, 360 and 370 may be skipped.

Alternatively, if the check result is positive, then, as indicated at block 350, a signal may be sent to indicate a change in one or more parameters, values, threshold values, attributes and/or properties used in a collision avoidance mechanism, such as used for the calculation of a CW or used for an RTS/CTS-related mechanism. The signal may include, for example, a wireless beacon signal or other one or more suitable signals, messages, frames, packets and/or indications. In some embodiments, the signal may be sent by station 250. The signal may, for example, include one or more frames. The signal may include, for example, a message or an indication that one or more adaptive values for a collision avoidance mechanism, such as CWₘᵢₙ and/or CWₘₐₓ, were determined by station 250, an indication that a wireless station is requested and/or required to modify its CWₘᵢₙ and/or CWₘₐₓ values to the corresponding adaptive values, and/or the determined adaptive values for CWₘᵢₙ and/or CWₘₐₓ. The signal may include other suitable data, for example, data indicating the identity or other properties of the sending or originating device, data indicating the identity or other properties of devices which need to receive and/or process the signal, and/or data indicating the date and time of the generation of the signal or of its content. For example, in one embodiment, station 250 may transmit a signal indicating adaptation of the size of a CW of a collision avoidance mechanism based on an estimated number of active stations of a wireless communication system or network; and station 110 may receive the signal and may adapt, set and/or modify the size of the CW. In some embodiments, the signal may include any suitable parameters, data, indications and/or adaptive values, to allow a station to modify one or more settings, parameter, functions and/or calculations, for example, its values for CWₘᵢₙ and/or CWₘₐₓ to the corresponding adaptive values.

It is noted that the signal may include data other than adaptive values for CWₘᵢₙ and/or CWₘₐₓ. For example, in some embodiments, in which adaptive values are determined for RTS/CTS-related threshold values, attributes and/or parameters, the signal may include an indication that such adaptive values were determined by station 250, an indication that a wireless station is requested and/or required to modify its corresponding threshold values, attributes and/or parameters, and/or the determined adaptive values of such threshold values, attributes and/or parameters. In one embodiment, the signal may include any suitable parameters, data, threshold values, attributes, indications and/or adaptive values, to allow a wireless station to modify one or more settings, parameters, functions, calculations, attributes, threshold values and/or parameters related to sending and/or receiving RTS frames, CTS frames, and/or related to RTS-protection mechanisms and/or transmission collision avoidance mechanisms.

As indicated at block 360, a station, for example, station 110, may receive the signal sent by station 250. The received signal and/or its content may be stored, for example, in memory 142 of station 110, in storage unit 143 of station 110, and/or in other suitable components of station 110.

As indicated at block 370, station 110 may set and/or modify one or more of its properties or parameters of a collision avoidance mechanism of station 110 and/or of network 200. Such modification may be, for example, in relation to a property of network 200. In some embodiments, station 110 may set and/or modify settings, parameters, functions and/or calculations, for example, its values for CWₘᵢₙ and/or CWₘₐₓ and/or its attributes, parameters and/or threshold values related to sending and/or receiving RTS frames and/or CTS frames, to match or substantially match the corresponding adaptive values. Optionally, in some embodiments, station 110 may perform other suitable operations related to setting and/or modifying its settings, parameters, functions and/or calculations, as indicated to station 110 by the signal sent by station 250. For example, station 110 may perform operations to modify the size of a CW, to modify a property or a parameter of a CW, and/or to turn on, turn off, or modify a property or a parameter of an RTS/CTS mechanism or another suitable collision avoidance mechanism. It is noted that such settings, modifications and/or operations may be performed, for example, using processor 141 of station 110, and/or using other suitable units, controllers and/or components of station 110.

As indicated at block 370, the above operations may be repeated. Optionally, in some embodiments, the repetition may be performed after a period of time, such as T2, has elapsed. In some embodiments, the value of T2 may be equal to zero or substantially zero, such that the above operations may be repeated continuously or substantially continuously, respectively. In some embodiments, the value of T2 may be equal, for example, to a pre-defined number of seconds. Various suitable values for T2 may be used.

The method of FIG. 3 may be used with various wireless communication networks, devices, systems, stations, APs, and/or apparatuses, which may be implemented using various suitable combinations of hardware and/or software. In some embodiments, various processors, memories, buffers, and/or other multi-purpose and/or dedicated components may be used to achieve specific functionalities and/or to perform methods in accordance with embodiments of the invention. In some embodiments, other methods and/or operations may be used, in addition to or instead of the series of operations described in FIG. 3. It is noted that in some embodiments, the operations described with reference to blocks 310, 320, 330, 340 and 350 may be performed, for example, by station 250, by station 110, by station 220, and/or by any other suitable terminal, device, computer, AP, computer, controller, circuit, circuitry, and/or station. For example, in some embodiments, a station (e.g., station 110) may determine, compute and/or calculate one or more adaptive values independently of another device (e.g., station 250).

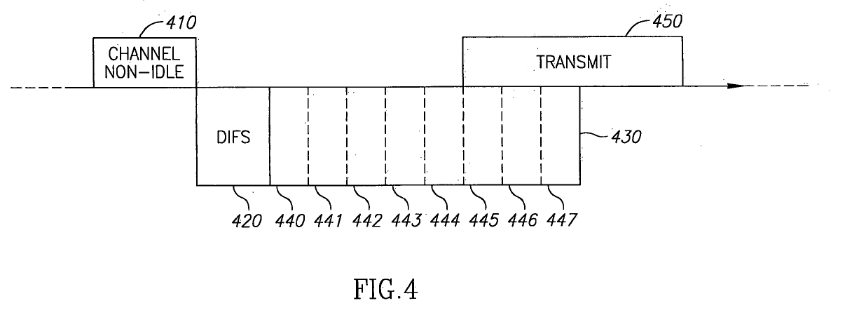

FIG. 4 is a schematic illustration of a possible time/transmission graph resulting from the operation of a method according to one embodiment of the invention. In the example illustrated in graph 400, events on the left side occur earlier than events on the right side.

As indicated at region 410, station 110 may detect that a wireless communication channel is busy or non-idle. Upon such detection, as indicated at region 420, station 110 may remain idle for a fixed period of time, such as DIFS. As indicated at region 430, station 110 may remain idle for a random period of time, which may be equal, for example, to the size of a CW. The size of the CW may be based on, for example a pseudo-random number of time slots. In some embodiments, the size of the CW may be calculated based on various functions and/or parameters, for example, in relation to the adaptive values of CWₘᵢₙ and CWₘₐₓ.

In the example illustrated in FIG. 4, the adaptive value of CWₘᵢₙ is equal to seven, such that the initial pseudo-random number of time slots may be between zero and seven, and such that region 430 may optionally include between zero to seven sub-regions 440, 441, 442, 443, 444, 445, 446 and 447. Other numbers of sub-regions may be used. When the waiting period elapses, station 110 may check if the wireless communication channel is idle. If the check result is positive, then station 110 may, for example, transmit a packet, as indicated at region 450. In this example, CWₘᵢₙ has an adaptive value which may be currently equal to seven. Therefore, the pseudo-random CW waiting period of station 110 may be equal to or smaller than seven time slots.

The result described above may provide various advantages. Some embodiments of the invention may allow using adaptive parameters in, for example, calculation of the size of a CW, e.g., using adaptive values of CWₘᵢₙ and/or CWₘₐₓ. Other parameters, properties, attributes and/or functions of a communication network may be modified and/or set. Embodiments of the invention may allow various benefits, for example, shorter CW-based waiting periods, increased throughput and/or effective throughput of wireless communications, and/or decrease and/or elimination of transmission collisions. It is noted that the invention is not limited in this respect, an that various embodiments of the invention may provide one or more of these benefits and/or other various benefits.

Some embodiments of the invention may be implemented, for example, using a machine-readable medium or article which may store an instruction or a set of instructions that, if executed by a machine (for example, by station 110, by processor 141 of station 110, by station 250, by processor 252 of station 250 and/or by other suitable machines), cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. In some embodiments, the machine-readable medium or article may include, for example, memory 142 of FIG. 1, storage unit 143 of FIG. 1, a storage article used in association with storage unit 143 of FIG. 1, or other suitable components. In some embodiments, the machine-readable medium or article may include, for example, any suitable type of memory unit, memory device, memory article, memory medium, storage device, storage article, storage medium and/or storage unit, e.g., memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level level, low-level, object-oriented, visual, compiled and/or interpreted programming language, e.g., C, C++, Java, BASIC, Pascal, Fortran, Cobol, assembly language, machine code, or the like.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors, or devices as are known in the art. Some embodiments of the invention may include buffers, registers, storage units and/or memory units, for temporary or long-term storage of data or in order to facilitate the operation of a specific embodiment.

While certain features of the invention have been illustrated and described herein, many modifications, substitutions, changes, and/or equivalents may occur to those skilled in the art. It is, therefore, to be understood that the appended claims are intended to cover all such modifications and/or changes.

1. A method comprising:
adapting a size of a contention window of a collision avoidance mechanism based on an estimated number of active stations of a communication network.

2. The method of claim 1, comprising dynamically modifying the size of said contention window.

3. The method of claim 1, comprising modifying a parameter used in computing the size of said contention window.

4. The method of claim 3, comprising modifying a parameter indicating a minimum size of the contention window.

5. The method of claim 3, comprising modifying a parameter indicating an initial maximum size of the contention window.

6. The method of claim 3, comprising modifying a parameter indicating a non-initial maximum size of the contention window.

7. The method of claim 3, comprising modifying the size of the contention window in relation to an estimated probability of collisions.

8. The method of claim 1, comprising sending a signal indicating a request for modification of the size of the contention window.

9. The method of claim 1, comprising modifying a threshold value of a request-to-send mechanism.

10. An apparatus comprising:
a processor to adapt a size of a contention window of a collision avoidance mechanism based on an estimated number of active stations of a communication network.

11. The apparatus of claim 10, wherein the apparatus comprises a wireless modem.

12. The apparatus of claim 10, wherein the apparatus comprises a wireless access point.

13. The apparatus of claim 10, wherein the processor is to modify a parameter used in computing the contention window.

14. The apparatus of claim 13, wherein the parameter used in computing the contention window comprises a parameter indicating a minimum size of the contention window.

15. The apparatus of claim 13, wherein the parameter used in computing the contention window comprises a parameter indicating an initial maximum size of the contention window.

16. The apparatus of claim 13, wherein the parameter used in computing the contention window comprises a parameter indicating a non-initial maximum size of the contention window.

17. The apparatus of claim 10, wherein the processor is to adapt the size of said contention window based on an estimated probability of collisions.

18. The apparatus of claim 10, wherein the processor is to modify a threshold value of a request-to-send mechanism.

19. A wireless communication device comprising:
a dipole antenna; and
a processor to adapt a size of a contention window of a collision avoidance mechanism based on an estimated number of active stations of a communication network.

20. The wireless communication device of claim 22, wherein the processor is to dynamically modify a parameter used in computing the contention window.

21. The wireless communication device of claim 22, wherein the processor is to dynamically modify a threshold value of a request-to-send mechanism.

22. A wireless communication system comprising:
a station to transmit a signal indicating adaptation of a size of a contention window of a collision avoidance mechanism based on an estimated number of active stations of said wireless communication system; and
a wireless communication device to receive the signal and adapt a size of the contention window.

23. The wireless communication system of claim 22, wherein the signal comprises a signal indicating modification of a parameter used in computing the contention window.

24. The wireless communication system of claim 22, wherein the signal comprises a signal indicating modification of a threshold value of a request-to-send mechanism.

25. A machine-readable medium having stored thereon a set of instructions that, if executed by a machine, cause the machine to perform a method comprising:
adapting a size of a contention window of a collision avoidance mechanism based on an estimated number of active stations of a communication network.

26. The machine-readable medium of claim 25, wherein the instructions result in dynamically modifying the size of said contention window.

27. The machine-readable medium of claim 25, wherein the instructions result in modifying a threshold value of a request-to-send mechanism.
